(19) United States
(12) Patent Application Publication
(10) Pub. No.: US 2002/0118746 A1
(43) Pub. Date: Aug. 29, 2002

(54) Method of performing video encoding rate control using motion estimation

(76) Inventors: Hyun Mun Kim, Scottsdale, AZ (US); Tinku Acharya, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/754,683

(22) Filed: Jan. 3, 2001

(51) Int. Cl. H04N 7/12

(52) U.S. Cl. 375/240.03; 375/240.24

(57) ABSTRACT

Embodiments of a method for video encoding rate control using motion estimation are disclosed.

### RELATED APPLICATIONS

This patent application is related to concurrently filed U.S. patent application Ser. No. ______, titled “Method of Performing Video Encoding Rate Control”, by Kim et al. (attorney docket no. 042390.P10264), filed on ______, and to concurrently filed U.S. patent application Ser. No. ______, titled “Method of Performing Video Encoding Rate Control using Bit Budget”, by Kim et al. (attorney docket no. 042390.P10587), filed on ______, both assigned to the assignee of the present invention and herein incorporated by reference.

### BACKGROUND

The present disclosure is related to rate control of the encoding of video images.

As is well-known, video encoding may be performed by any one of a number or variety of techniques. Common techniques that are frequently employed comply with certain established standards, such as the ‘MPEG” (Moving Pictures Expert Group) and ‘H.26x’ standards. These include the following: ITU-T “Video coding for low bit-rate communications,” ITU-T Recommendation H.263, version 1, Nov.1995 and version 2, January 1998; “Generic Coding of Moving Pictures and Associated Audio Information: Video,” ISO/IEC 13818-2: International Standard 1995; and “Coding of audio-visual Objects-Part 2: Visual Amendment 1; Visual extensions,” ISO/IEC 14496-2: Draft of Jan. 6, 2000; respectively, referred to specifically as H.263, H.263+, MPEG-2, and MPEG-4 and generally as MPEG and H.26x, hereinafter. Such standards, however, define bit stream syntax so that any standard compliant decoder may be employed to decode the encoded video. This provides encoders with a relatively large amount of flexibility in terms of implementation.

Rate control, such as bit rate control, is one of the issues not generally specified for the video encoder, therefore, making it possible to provide the capability to employ a variety of different techniques. Furthermore, applying rate control may impact the processing of video in several respects. In one respect, rate control may be employed to maintain buffer constraints and, thereby, prevent overflow and/or underflow during encoding and, in particular, in connection with real-time applications. Likewise, in another respect, rate control may also impact picture quality.

In addition to rate control, there are other parameters that may be varied by an encoder during encoding that may result in various levels of image distortion, and, therefore, impact performance. Therefore, it may, at times, be difficult to improve the image quality to an acceptable level while also meeting various desired constraints, such as, for example, a total bit budget, employing an appropriate amount of delay, etc.

Techniques exist to balance these considerations in order to provide acceptable or desirable solutions. Examples include employing Lagrangian optimization or dynamic programming. Unfortunately, however, such techniques are frequently or typically computationally complex and, therefore, expensive in terms of the amount of processing resources consumed by such an approach. Furthermore, the dependency that typically exists between images or image frames in the processing of video may, at times, make addressing such issues even more complex. For example, the distortion of the current frame may depend at least in part on the selection of quantization parameters, for example, for the previous frame or frames. Therefore, a technique for performing rate control in video encoding that is less computationally complex than previous or state of the art approaches, but that also balances at least some of the foregoing complex considerations, is desirable.

### BRIEF DESCRIPTION OF THE DRAWINGS

The subject matter regarded as the invention as particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is block diagram illustrating a video encoder that may employ an embodiment of a method of performing video encoding rate control using Motion Estimation in accordance with the present invention;

FIG. 2 is a series of plots illustrating the relationship between macroblock SAD and bit count for various picture types for a specific number of quantization bins;

FIG. 3 is a table illustrating the adaptive quantization approach employed in the Test Model No. 5 (TM5) macroblock level rate control, as proposed in the verification model proposed by the MPEG-2 committee; and

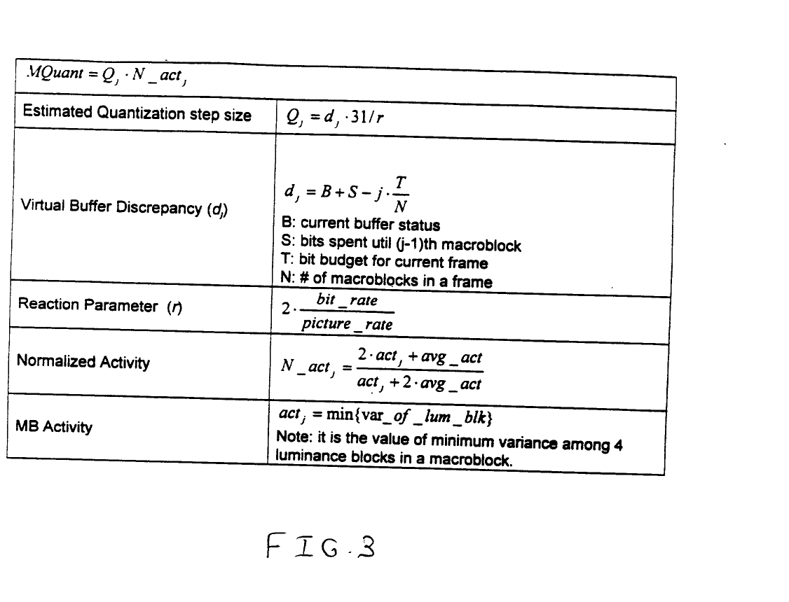

FIG. 4 is a table illustrating the comparison of performance parameters between the TM5 control approach and an embodiment of a method of performing video encoding rate control using Motion Estimation in accordance with the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

As previously described, video encoding rate control may be a feature of a video encoder. Although the invention is not limited in scope in this respect, in one embodiment of a method of performing video encoding rate control in accordance with the present invention, the video bit rate employed during video encoding is varied based at least in part on an estimate of motion for a selected portion of a video image being encoded. For example, motion estimation provides information about prediction mode decisions, motion vector choices, and displaced frame difference coding fidelity. Therefore, an estimate of motion may be useful to employ in connection with video encoding rate control.

Therefore, for this particular embodiment, although, of course, the invention is not limited in scope in this respect, a relationship may be employed between an estimate of the motion and the associated video encoding rate control to be applied by the video encoder. Furthermore, although there are a variety of techniques that may be employed to estimate motion and the invention is not limited in scope to any particular technique, in this particular embodiment, the motion may be estimated using the sum of absolute differences (SAD).

$$SAD = {min}_{( x , y ) ∈ S} {\sum }_{j = 0}^{15} {\sum }_{i = 0}^{15} \vert C [ i , j ] - R [ {x}_{0} + x + i , {y}_{0} + y + j ] \vert \qquad [ 1 ]$$

where

(x₀, y₀) upper left corner coordinates of the current macroblock

C[x, y] current macroblock luminance samples

R[x, y] reconstructed previous frame luminance samples

S search range: {(x,y):−16≦x,y<16}

As is well-known, the SAD values are computed in all or some selected search points in the search space (S). The motion vector (MVx, MVy) is selected based on the displacement of the search point which results in the minimum SAD among all the SAD values in the search space. It is noted, of course, that other potential estimates of motion are essentially a substitute of the SAD. For example, the mean absolute difference (MAD) may be employed in place of the SAD and should provide nearly identical, if not identical, results. Therefore, such other substitute estimates are clearly within the scope of the invention.

In this context, the SAD provides several advantages. It is already computed as part of motion estimation, and, therefore, introduces little or no additional overhead in terms of the consumption of processing resources. Furthermore, motion estimation provides information that may be useful in terms of video encoding rate control, as previous indicated.

In this context, it is noted that a modification in quantization step size specifically results in an adjustment of a video encoding rate, here the video encoding bit rate. Therefore, although, again, the invention is not limited in scope in this respect, for this embodiment, adjusting the quantization step size is a mechanism employed to modify or adjust the video encoding rate. This follows at least in part from the observation that a high quantization step size provides relatively coarse quantization. Thus, the amount of information to be sent to the decoder is reduced when employing a high quantization step size.

It may in this context be desirable to appropriately characterize the relationship between the bit count employed to encode a macroblock and the SAD of the macroblock, at least for this particular embodiment. Therefore, for different values of a quantization step size parameter, here from one to 31, these particular parameters are computed for a variety of images. Of course, this is just one potential methodology and any one of a number of methodologies may be employed. The invention is not limited in scope to employing any particular methodology. Therefore, furthermore, in this particular embodiment, as shall be described in more detail hereinafter, the macroblocks (MBs) are classified by type, such as inter, intra, B and 4 MV. In this context, ‘intra’ refers to a MB coded without motion vectors, ‘inter’ refers to a MB that uses one forward motion vector, ‘4 MV’ refers to a MB that uses four forward motion vectors, and B refers to a MB that uses forward and backward motion vectors to reduce temporal redundancy, although, again, the invention is not limited in scope in this respect. It is noted that the modes also provide information based on motion estimation that may be useful in video encoding rate control.

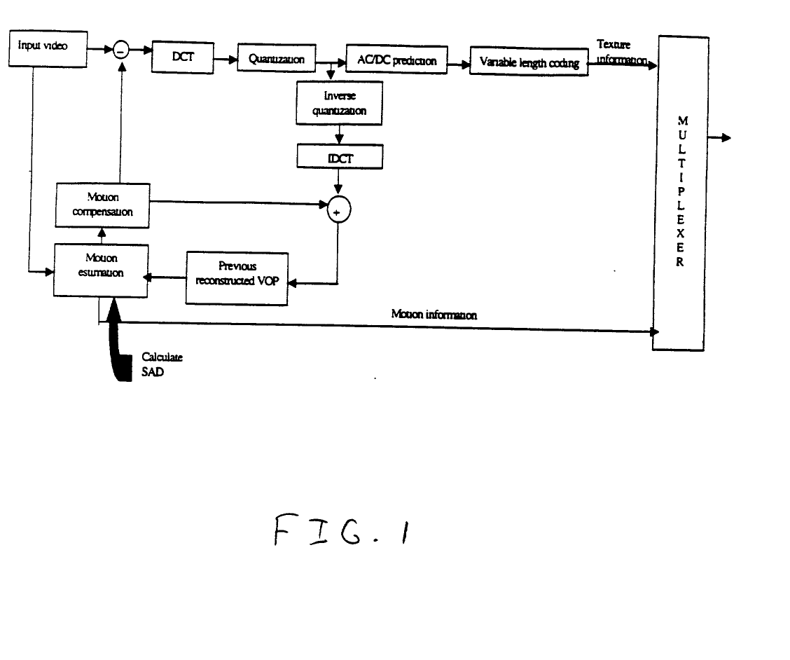

In this particular embodiment, although, again the invention is not limited in scope to employing this particular methodology, the SAD is obtained after motion estimation has been performed, such as at the point shown in the block diagram illustrated in FIG. 1, except for intra macroblocks, of course. This point in FIG. 1 is chosen so that the mode of each macroblock using the results of motion estimation may be obtained for this particular embodiment.

Using this methodology or approach, a relationship between macroblock SAD and the count may be generated for each quantization parameter or step-size. In this particular implementation, based upon the quantization parameter or step-size, 31 figures may, therefore, be generated, although this is not intended to be limiting on alternate approaches within the scope of the present invention. Here, then, for each different quantization step-size, from a number of macroblocks having SADs, the total number of bits is determined. Likewise, as previously described, the different macroblock types may also be employed. The relationship between SAD and bit count may be shown to depend at least in part on type of macroblock, in addition to depending at least in part on the SAD of the macroblock, at least for this particular implementation; however, as previously indicated, the invention is not limited in scope to this particular implementation.

In order to make the data generated suitable for use in video encoding rate control, it is desirable to quantize the macroblock SAD, although, again, of course, the invention is not limited in scope in this respect. For example, some other embodiments may employ the foregoing approach regarding SAD without applying quantization. Nonetheless, the following quantization technique is employed in this particular embodiment. Of course, any one of a number of other suitable techniques may alternatively be employed, and all such other quantization techniques are included within the scope of the present invention because the particular technique applied is not significant. However, in this particular embodiment or methodology, the following quantization technique is employed.

index =SAD/bin_size [2]

where bin_size=range/no_bins

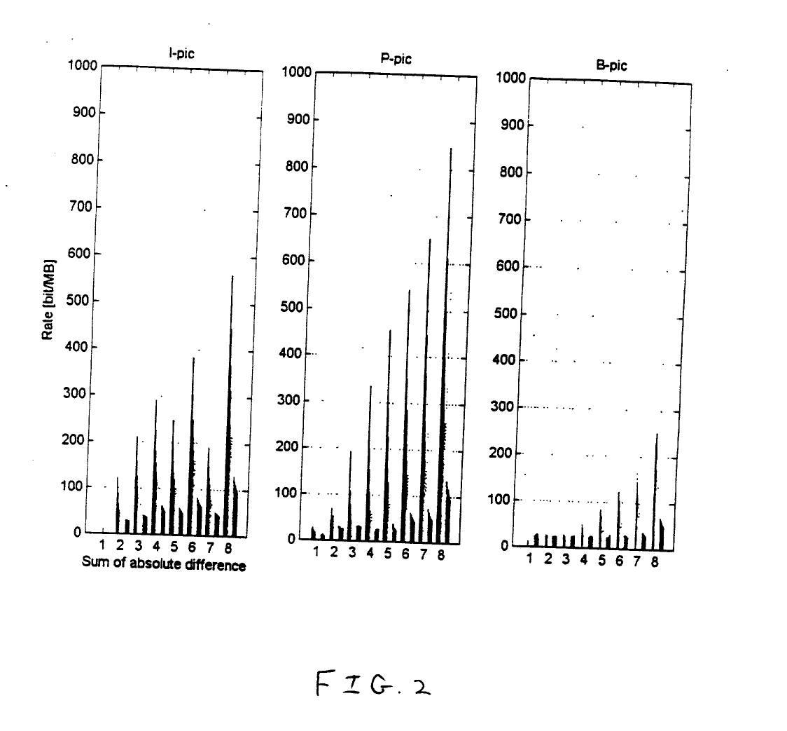

In equations [2], ‘SAD’ is, of course, the macroblock SAD. Likewise, ‘no_bins’ is 8. For a given quantization step-size, in this embodiment, it is then desirable to average the bit count depending upon the particular index. This is illustrated by the plots in FIG. 2 depending on the picture types employed, in this implementation, types I, P, or B. It is noted that such picture types are employed in connection with MPEG compliant video encoders, although, again, the invention is not limited in scope to MPEG or compliance with MPEG.

The plots shown in FIG. 2 illustrate on one graph the relationship between SAD and bit count where quantization step-size is held constant for each separate curve, but varied across the family of curves shown on each respective plot. Using this data, therefore, for a video encoder, the video bit rate to be employed may be varied to take into account the SAD of a macroblock, and/or the macroblock type. More specifically, by quantizing the total number of bits and the macroblock SAD, the plots as shown in FIG. 2 may be converted into lookup tables (LUTs) that may be stored and employed by a video encoder during the process of encoding video to apply video encoding rate control. For these plots, 40 bins were employed for bit count for each picture type, although, of course, the invention is not limited in scope in this respect.

For such an embodiment, the following methodology may be employed, although, again, the invention is not limited in scope in this respect. A bit count is to be assigned to each macroblock. First, a bit count may be allocated to a particular frame using any picture level rate control, such as TM5, for example, although the invention is not limited in scope in this respect. The SAD of the macroblocks in the image may then be employed to determine the bit count to be employed for the macroblocks in the frame or picture. Thus, in this embodiment, after calculating the SAD of the macroblocks, the number of bits, Rᵢ, for a macroblock, respectively designated numerically by the subscript, i, may be calculated as follows:

Rᵢ=Tₓ[SADᵢ^{k}/(SAD₁^{k} + . . . +SADₙ^{k})] [3]

where T is the number of bits for the current picture, n is the number of macroblocks and k is a parameter that may be employed to adjust sensitivity to differences in SAD. For example, for a low value of k, such as like k<1, the assigned bits are less sensitive to the difference in SAD.

Therefore, by using the equation above to determine Rᵢ for the current macroblock and computing its associated SAD, the lookup tables, depending on picture type and after quantizing the SAD and Rᵢ, may be used to determine the quanitization step-size, which, as previously explained, for this particular embodiment, will ultimately result in an adjustment of the video encoding rate.

In comparison with state of the art approaches to adjusting the video bit rate, an embodiment in accordance with the present invention has several advantages. One advantage of this particular embodiment is reduced computational complexity. For this particular embodiment, for example, two parameters that may be determined with relative computational ease are employed to adjust or control the video encoding rate. One parameter, in this embodiment, although again the invention is not limited in scope in this respect, is an estimate of the motion. In terms of computational complexity, this does not produce a significant amount of additional overhead because this calculation takes to determine macroblock mode, as previously described, except for I frames. Furthermore, this computation for I frames, although providing some additional overhead, is not significant in terms of the processing resources that are consumed.

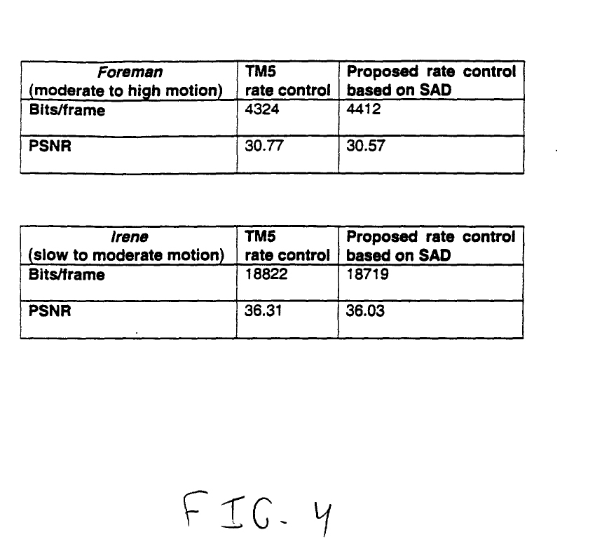

FIG. 4 is a table illustrating the approach employed for TM5. If for the sake of argument, it is assumed that the computational complexity of computing macroblock SAD is about the same as the computational complexity of computing of macroblock activity, as that term is used in TM5, then, the complexity of the previously described embodiment when applied a group of pictures (GOP) decreases computation complexity by a factor of the number of frames other than I frames over TM5 because the SAD calculation is not overhead while an activity calculation is overhead for TM5. For example, assuming 15 pictures for a GOP, the ratio of I pictures is 14/15 or 93%. This suggests a potential computational savings of 93%.

FIG. 5 is a table providing a comparison between various performance parameters for an embodiment in accordance with the invention and TM5. This data was generated from two image sequences. One of the sequences employed moderate to high motion with QCIF size. The other sequence employed slow to moderate motion with CIF size. 150 frames from each was employed with a frame rate of 15 frame per second. The number of B frames between P or I frames is 2 and the intra period is 15 frames. The data in the table implies that the degradation in performance quality is slight, here only about 0.3 db in both sequences for luminance pictures, for a substantial decrease in computational complexity.

The previously described embodiments provide a number of desirable advantages and features. For example, as previously explained, the implementation of a rate control mechanism such as those previously described reduces computation complexity by an amount in the neighborhood of 93%. Therefore, although results may vary depending on a variety of factors, such embodiments may be suitable for low-power applications, as is often desirable. Likewise, the previously described embodiments may be implemented in hardware, software, firmware, or any combination thereof. Furthermore, embodiments in accordance with the invention provide compatibility with known video standards, such as MPEG and H.26x.

It will, of course, be understood that, although particular embodiments have just been described, the invention is not limited in scope to a particular embodiment or implementation. For example, one embodiment may be in hardware, whereas another embodiment may be in software. Likewise, an embodiment may be in firmware, or any combination of hardware, software, or firmware, for example. Likewise, although the invention is not limited in scope in this respect, one embodiment may comprise an article, such as a storage medium. Such a storage medium, such as, for example, a CD-ROM, or a disk, may have stored thereon a look up table, such as previously described. Likewise, a storage medium may have stored instructions, which when executed by a system, such as a computer system or platform, or an imaging system, for example, may result in an embodiment of a method in accordance with the present invention being executed, such as an embodiment of a method of performing video encoding rate control using motion estimation, for example, as previously described. For example, a video processing platform or an imaging system may include a video encoder, a video input device and memory. The video encoder may include a mechanism to adjust the video encoding rate employed during video encoding, such as by employing one of the embodiments previously described, for example. Furthermore, embodiments of the invention are also not limited to video encoders or video encoding. For example, video may be decoded where the video had been encoded using an embodiment in accordance with the invention, again, such as previously described.

While certain features of the invention have been illustrated and described herein, many modifications, substitutions, changes and equivalents will now occur to those skilled in the art. It is, therefore, to be understood that the appended claims are intended to cover all such modifications and changes as fall within the true spirit of the invention.

1. A method of performing video encoding comprising:
adjusting a video encoding rate employed during video encoding based at least in part on an estimation of motion for a selected portion of a video image being encoded.

2. The method of claim 1, wherein the selected portion of the video image comprises a macroblock.

3. The method of claim 2, wherein the video encoding rate is also adjusted based at least in part on the type of macroblock.

4. The method of claim 3, where in the types comprise at least one of the following: intra, inter, 4 MV, and B.

5. The method of claim 1, wherein the video encoding rate is adjusted by adjusting the quantization step size employed during video encoding.

6. The method of claim 5, wherein the selected portion of the video image comprises a macroblock.

7. The method of claim 6, wherein the video encoding rate is also further adjusted based at least in part on the type of macroblock.

8. The method of claim 7, wherein the types comprise at least one of the following: intra, inter, 4 MV, and B.

9. The method of claim 1, wherein the video encoding performed is substantially MPEG or H.26x compliant.

10. The method of claim 1, wherein the estimate of the motion comprises the sum of absolute differences (SAD) or its substitute.

11. A device having the capability to perform video encoding comprising:
a mechanism to adjust a video encoding rate employed during the video encoding based at least in part on an estimate of motion for a selected portion of a video image being encoded;
wherein said mechanism is implement within a video encoder.

12. The device of claim 11, wherein said video encoder is implemented in silicon on at least one integrated circuit.

13. The device of claim 12, wherein the silicon implementation of said video encoder comprises microcode.

14. The device of claim 12, wherein the silicon implementation of said video encoder comprises firmware.

15. The device of claim 11, wherein said video encoder is implemented in software capable of executing on a processor.

16. The device of claim 15, wherein said processor comprises a microprocessor.

17. The device of claim 11, wherein the estimate of the motion comprises the SAD or its substitute.

18. An article comprising: a storage medium, said medium having stored thereon instructions that, when executed, result in the performance of video encoding by:
adjusting a video encoding rate employed during video encoding based at least in part on an estimate of motion for a selected portion of a video image being encoded.

19. The article of claim 18, wherein said medium further has stored thereon instructions that, when executed, result in the selected portion of the video image being encoded comprising a macroblock.

20. The article of claim 19, wherein said medium further has stored thereon instructions, that, when executed, result in the video encoding rate being adjusted also based at least in part on the type of macroblock.

21. The article of claim 18, wherein said medium further has stored thereon instructions that, when executed, result in the estimate of motion comprising the SAD or its substitute.

22. The article of claim 18, wherein said medium further has stored thereon instructions that, when executed, result in the video encoding rate being adjusted by adjusting the quantization step size employed during video encoding.

23. A video processing platform comprising:
a video encoder;
a video input device coupled to said video encoder; and
memory;
wherein said memory is coupled to said video encoder to store video encoded by said video encoder; and
wherein said video encoder includes a mechanism to adjust a video encoding rate employed during video encoding based at least in part on an estimate of motion for a selected portion of a video image being encoded.

24. The system of claim 23, wherein the selected portion of the video image comprises a macroblock.

25. The system of claim 24, wherein the mechanism to adjust the video encoding rate employed during video encoding is also based at least in part on the type of macroblock.

26. The system of claim 23, wherein the mechanism to adjust the video encoding rate employed during video encoding is adjusted by adjusting the quantization step size employed during video encoding.

27. The system of claim 23, wherein the estimate of the motion comprises the SAD or its substitute.

28. A method of performing video decoding comprising:
decoding video that has been encoded, wherein said encoded video was encoded by adjusting a video encoding rate employed during video encoding based at least in part on an estimate of motion for a selected portion of a video image being encoded.

29. The method of claim 28, wherein the selected portion of the video image comprises a macroblock.

30. The method of claim 29, wherein the video encoding rate is also adjusted based at least in part on the type of macroblock.

31. The method of claim 28, wherein the video encoding rate is adjusted by adjusting the quantization step size employed during video encoding.

32. The method of claim 28, wherein the selected portion of the video image comprises a macroblock.

33. The method of claim 32, wherein the video encoding rate is also further adjusted based at least in part on the type of macroblock.

34. The method of claim 28, wherein the estimate of the motion comprises the SAD or its substitute.

35. A video processing platform comprising:
a video decoder;
a video output device coupled to said video decoder; and
memory;
wherein said memory is coupled to said video decoder to store video previously encoded by a video encoder, wherein said video encoder included a mechanism to adjust a video encoding rate employed during the video encoding based at least in part on an estimate of motion for a selected portion of a video image being encoded.

36. The system of claim 35, wherein the selected portion of the video image comprises a macroblock.

37. The system of claim 36, wherein the mechanism to adjust the video encoding rate employed during video encoding is also based at least in part on the type of macroblock.

38. The system of claim 35, wherein the mechanism to adjust the video encoding rate employed during video encoding is adjusted by adjusting the quantization step size employed during video encoding.

39. The system of claim 35, wherein the estimate of the motion comprises the SAD or its substitute.

40. An article comprising: a storage medium, said medium having stored thereon instructions that, when executed, result in the performance of video decoding by:
decoding video that has been encoded, wherein said encoded video was encoded by adjusting a video encoding rate employed during video encoding based at least in part on an estimate of motion for a selected portion of a video image being encoded.

41. The article of claim 40, wherein said medium further has stored thereon instructions that, when executed, result in the selected portion of the video image being encoded comprising a macroblock.

42. The article of claim 41, wherein said medium further has stored thereon instructions, that, when executed, result in the video encoding rate being adjusted also based at least in part on the type of macroblock.

43. The article of claim 40, wherein said medium further has stored thereon instructions that, when executed, result in the video encoding rate being adjusted by adjusting the quantization step size employed during video encoding.

44. A method of creating a video encoding rate control table comprising:
computing a relationship between the number of bits and SAD or its substitute of a plurality of video images for a variety of quantization step sizes;
preparing a look up table to provide quantization step size substantially in accordance with the computed relationship.

45. The method of claim 44, wherein the relationship is computed for subportions of the video images.

46. The method of claim 45, wherein the subportions comprise macroblocks.

47. The method of claim 46, wherein the relationship is computed for macroblock types.

48. The method of claim 45, wherein the look up table is prepared by quantizing the number of bits and the SAD or its substitute.

49. An article comprising:
a storage medium having stored thereon a look up table, said table comprising a relationship between the number of bits and SAD or its substitute of a plurality of video images for a variety of quantization step sizes.

50. The article of claim 49, wherein said storage medium further includes instructions stored thereon to employ the look up table to perform video encoding rate control.

51. The article of claim 50, wherein the look up table is employed to perform video encoding rate control when the instructions are executed by a processor.
